(19) United States
(12) Patent Application Publication
(10) Pub. No.: US 2026/0267004 A1
(43) Pub. Date: Sep. 10, 2026

(54) GUIDANCE AND NAVIGATION SYSTEM FOR AN AIRCRAFT

(71) Applicant: THALES, MEUDON (FR)

(72) Inventors: Denis BOUVET, VALENCE (FR); Pierre-Yves DUMAS, VALENCE (FR)

(21) Appl. No.: 19/130,017

(22) PCT Filed: Nov. 8, 2023
(86) PCT No.: PCT/EP2023/081184

§ 371 Date: May 14, 2025

(30) Foreign Application Priority Data
Nov. 14, 2022 (FR) FR2211800

(51) Int. Cl. G01S 19/21; G01S 19/08; H04L 9/32

(52) U.S. Cl. CPC G01S 19/21; G01S 19/08; H04L 9/32; H04L 2209/84

(57) ABSTRACT

A guidance and navigation system for an aircraft includes: a GNSS receiver configured to receive GNSS signals, as well as SBAS signals in at least one SBAS service area, these signals including GNSS and SBAS messages provided with at least one authentication information item encrypted by means of a private key, and the receiver comprising a signal processing module provided with a module for extracting and for transmitting said messages; and a device (DD) for extracting said at least one authentication information item for the messages, which is transmitted by the signal processing module and for decrypting it, by means of a public key, configured to output at least one validity/invalidity information item for the messages received.

### CROSS-REFERENCE TO RELATED APPLICATIONS

This application is a National Stage of International patent application PCT/EP2023/081184, filed on Nov. 8, 2023, which claims priority to foreign French patent application No. FR 2211800, filed on Nov. 14, 2022, the disclosures of which are incorporated by reference in their entireties.

### FIELD OF THE INVENTION

The invention relates to a guidance and navigation system for an aircraft, using at least one satellite navigation receiver.

### BACKGROUND

The dependence of the transport and in particular aviation industry on the global navigation satellite system (GNSS), using one or more satellite constellations, such as the American GPS system or the European Galileo system, has underlined the importance of the accuracy and integrity of the operation of these receivers, in particular those developed according to the RTCA/DO-229 standard, particularly with respect to possible interference.

### SUMMARY OF THE INVENTION

One aim of the invention is to provide a guidance and navigation system for a civilian aircraft making use of GNSS and SBAS (satellite-based augmentation system) signals, and which is less sensitive to interference.

The SBAS augmentation of one or more GNSS satellite constellations is monitoring of the GNSS signals and messages transmitted by these satellites. Said monitoring then derives (correction and warning) messages, referred to as “SBAS augmentation messages”, allowing civil aviation performance criteria to be met. These augmentation messages are transmitted to the user receivers from the SBAS monitoring via one or more satellites, referred to as SBAS satellites, which are generally geostationary and cover the SBAS service area. Below, the (position, speed, time) navigation solution calculated on the basis of the navigation signals and data of the GNSS satellites by applying the corrections and warnings received from an SBAS system will be referred to as the “SBAS augmented solution”. Some SBAS augmentation systems are designed so that all or some of the signals of the SBAS satellites are also used to derive the navigation solution in the same way as the GNSS signals. Since this aspect has no impact on the invention, it will not be mentioned again below.

Interference is a phenomenon whereby unwanted signals are received by the GNSS receiver, mix with the signals of the GNSS or SBAS satellites and interfere with the operation of the receiver.

Such interference may result in an inability to correctly decode legitimate signals originating from the satellites.

There is also the problem of cross-correlation or substitution of signals, which may interfere with the operation of the receiver, in that it uses a signal and messages originating from a source other than the one selected.

In order to mitigate the problems mentioned above, it is anticipated that the open or civilian services of some constellations (for example Galileo via OSNMA, an acronym of Open Service Navigation Message Authentication), or some SBAS systems transmit, in addition to the navigation or augmentation messages (designated “messages” below), authentication data allowing the messages received to be authenticated.

The aim of the present invention is to apply to any authentication information item transmitted on open GNSS signals and/or on SBAS signals.

According to one aspect of the invention, a guidance and navigation system for an aircraft is proposed, comprising:
a GNSS receiver configured to receive GNSS signals, as well as SBAS signals in at least one SBAS service area, these signals comprising GNSS and SBAS messages provided with at least one authentication information item encrypted by means of a private key, and the receiver comprising a signal processing module provided with a module for extracting and for transmitting said messages; and
a device for extracting said at least one authentication information item for the messages, which is transmitted by the signal processing module and for decrypting it, by means of at least one public key, configured to output at least one validity/invalidity information item for the messages received; the extraction and decryption device being integrated into a system which is external to the GNSS receiver.

In one embodiment, the device for extracting and for decrypting said at least one validity/invalidity information item for the one or more messages is configured to deliver said validity/invalidity information item for the one or more messages to the GNSS receiver.

According to one embodiment, the device for extracting and for decrypting at least one validity/invalidity information item for the one or more messages is configured to deliver said validity/invalidity information item for the one or more messages to other devices of the aircraft.

In one embodiment, the GNSS receiver is configured to provide at least one validity information item for the (position, speed, time) GNSS solution and/or the (position, speed, time) SBAS augmented solution, said validity information item being consolidated, taking into account the validity/invalidity information item for each message or group of messages.

What is meant by GNSS solution is a position value, a speed value and a time value derived on the basis of the GNSS signals received.

In other words, when a validity information item for a message or a group of messages is determined to be invalid, this or these messages are not taken into account or are labeled as erroneous.

According to one embodiment, the GNSS receiver is configured to transmit the validity/invalidity information item for the GNSS solution and, in an SBAS service area, the SBAS augmented solution, to other devices of the aircraft.

For example, another device of the aircraft is a cockpit display device for the pilot of the aircraft.

In one embodiment, the extraction and decryption device is integrated into a flight management system or FMS.

### BRIEF DESCRIPTION OF THE DRAWINGS

The invention will be better understood on studying a few embodiments described by way of completely non-limiting examples and illustrated by the appended FIG. 1, which schematically illustrates:

FIG. 1 shows a guidance and navigation system for an aircraft comprising a GNSS receiver R configured to receive the GNSS signals comprising the GNSS navigation messages and the SBAS signals in an SBAS service area, the latter comprising SBAS augmentation messages, the former and/or the latter being provided with an authentication information item encrypted by means of at least one private key. The receiver R comprises a signal processing module SP provided with a module ETM for extracting and for transmitting the GNSS and SBAS navigation messages (designated “messages” here).

### DETAILED DESCRIPTION

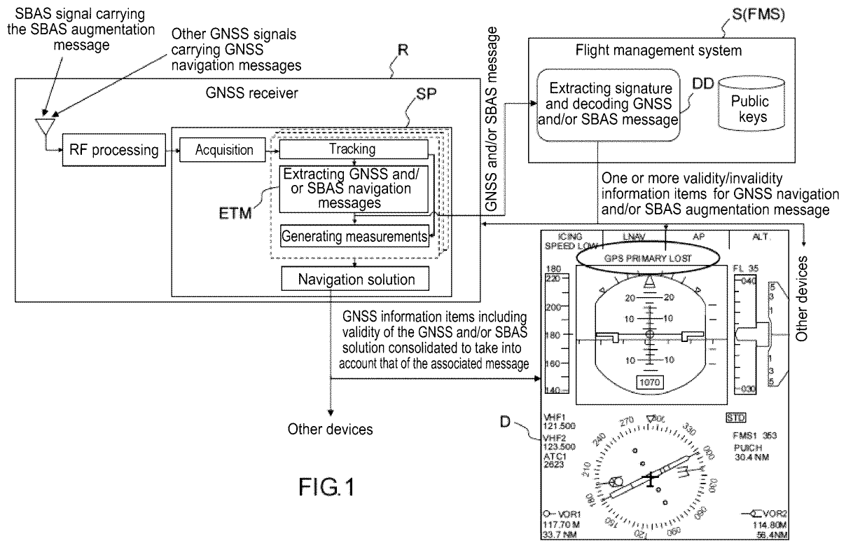

Only the elements which are specific to the present invention are described in detail; the other conventional elements of the GNSS receiver R are shown only in FIG. 1.

Furthermore, the guidance and navigation system comprises a device DD for extracting said authentication information item for the messages, which is transmitted by the signal processing module SP and for decrypting it, by means of one or more public keys, configured to output a validity/invalidity information item for the one or more messages. The extraction and decryption device DD is integrated into a system which is external to the GNSS receiver.

Such a system may easily be implemented, in particular in the context of aircraft which are subject to certification, by adapting existing GNSS receivers, with few modifications, whether they are only software or also hardware modifications.

The validity/invalidity information item for the one or more messages is delivered by the extraction and decryption device DD to the GNSS receiver R and possibly to other devices D of the aircraft, such as a device for displaying flight information for the pilot of the aircraft.

Thus, the GNSS receiver R and/or other external devices D, such as a cockpit display device, may invalidate, if necessary, the information items provided by the GNSS receiver R.

Furthermore, the GNSS receiver R is configured to consolidate a validity information item for the GNSS (position, speed, time) solution and, in an SBAS service area, for the SBAS augmented solution by taking into account the validity/invalidity information item for the one or more messages. The validity/invalidity information item for the one or more messages has an impact only on the GNSS or SBAS augmented solution concerned by the one or more messages; the other (position, speed, time) GNSS solutions not concerned by the one or more messages are not affected by the validity or invalidity of the one or more messages.

The GNSS receiver R may thus transmit the validity information item for the one or more solutions to other devices D of the aircraft.

The function of authenticating the information messages is not in the GNSS receiver. It is moved to a third-party device. Thus, a standard receiver is used which transmits all the GNSS messages received, and allows another device to host and maintain the public keys which are necessary for authenticating the messages. The present invention allows the secure SBAS messages to be implemented on the GNSS receivers in service. Without this innovation, making use of the secure SBAS messages would require a profound modification of all of the GNSS receivers in use, which would probably take many years.

The decryption device may be integrated into a flight management system FMS.

1. A guidance and navigation system for an aircraft comprising a GNSS receiver (R) configured to receive GNSS signals, as well as SBAS signals in at least one SBAS service area, these signals comprising GNSS and SBAS messages provided with at least one authentication information item encrypted by means of at least one private key, and the receiver (R) comprising a signal processing module (SP) provided with a module (ETM) for extracting and for transmitting said messages, comprising:
a device (DD) for extracting said at least one authentication information item for the messages, which is transmitted by the signal processing module (SP) and for decrypting it, by means of at least one public key, configured to output at least one validity/invalidity information item for the messages received; the extraction and decryption device (DD) being integrated into a system which is external to the GNSS receiver.

2. The system as claimed in claim 1, wherein the device (DD) for extracting and for decrypting said at least one validity/invalidity information item for the one or more messages is configured to deliver said validity/invalidity information item for the one or more messages to the GNSS receiver (R).

3. The system as claimed in claim 2, wherein the device (DD) for extracting and for decrypting at least one validity/invalidity information item for the one or more messages is configured to deliver said validity/invalidity information item for the one or more messages to other devices (D) of the aircraft.

4. The system as claimed in claim 2, wherein the GNSS receiver (R) is configured to provide at least one validity information item for the GNSS solution and/or the SBAS augmented solution, said validity information item being consolidated, taking into account the validity/invalidity information item for each message or group of messages.

5. The system as claimed in claim 4, wherein the GNSS receiver (R) is configured to transmit the validity/invalidity information item for the GNSS solution and, in an SBAS service area, the SBAS augmented solution, to other devices of the aircraft.

6. The system as claimed in claim 2, wherein another device (D) of the aircraft is a cockpit display device for the pilot of the aircraft.

7. The system as claimed in claim 1, wherein the extraction and decryption device (DD) is integrated into a flight management system (FMS).
